(19) United States
(12) Patent Application Publication
(10) Pub. No.: US 2011/0253694 A1
(43) Pub. Date: Oct. 20, 2011

(54) Radiant Heating Tile System

(76) Inventor: Nunzio Consiglio, Mississauga (CA)

(21) Appl. No.: 12/761,555

(22) Filed: Apr. 16, 2010

(51) Int. Cl. H05B 3/02

(52) U.S. Cl. 219/213

(57) ABSTRACT

The present invention is a radiant heating tile system for installation on a supporting surface. The system utilizes a plurality of modular heating tiles, the modular heating tiles each being substantially flat and having a substantially equal thickness. Each of the heating tiles have parallel top and bottom surfaces, a plurality of sides and an electrical heating element. The heating tiles each also have an insulator layer covering the bottom surface of the tile. The electrical heating element of each of the heating tiles is electrically coupled to a male electrical coupling contained in a notch formed on a first side of said tile. The electrical heating element of each of the heating tiles is also electrically coupled to a female electrical coupling contained in a notch formed on a second side of said tile opposite the first side. The male and female couplings are configured and the notches are positioned such that when two of said heating tiles are abutted together in side to side orientation, the male coupling of one heating tile is aligned with and can couple to the female coupling of the other tile.

### FIELD OF THE INVENTION

The invention relates generally to radiant heating tiles for heating a floor surface.

### BACKGROUND OF THE INVENTION

Radiant heating tiles have been in existence for some time. These tiles generally consist of a concrete aggregate tile containing a heating element such as an electrical heating element or a conduit for conducting a heated liquid such as water. The heating element applies heat energy to the tile, which in turn radiates the heat. These radiant heating tiles are generally used to form radiant heating floors which heat a room from below. Depending on the application, the heat applied by the heating element is generally only sufficient to heat the floor to approximately the desired room temperature.

Radiant heating tiles have several problems, not least of which is the often complicated and labor intensive nature of their installation. They are also often insufficiently resilient and durable to be used with outdoor applications, such as melting snow and ice on walkways. Therefore, an improved radiant heating tile system having improved efficiency and ease of assembly, would be advantageous.

### SUMMARY OF THE INVENTION

In accordance with one aspect of the present invention, there is provided a radiant heating tile system for installation on a supporting surface such as the ground. The system includes at least one heating tile having substantial flat parallel top and bottom surfaces and a plurality of sides. A heating element passes through the tile substantially parallel to the top and bottom surfaces. The tile further includes an insulator layer covering the bottom surface of the tile, and a plurality of feet formed on the insulator layer for supporting the tile above the supporting surface.

In accordance with another aspect of the present invention, there is provided a radiant heating tile system for installation on a supporting surface which utilizes a plurality of modular heating tiles, the modular heating tiles each being substantially flat and having a substantially equal thickness. Each of the heating tiles have parallel top and bottom surfaces, a plurality of sides and an electrical heating element. The heating tiles each also have an insulator layer covering the bottom surface of the tile. The electrical heating element of each of the heating tiles is electrically coupled to a male electrical coupling contained in a notch formed on a first side of said tile. The electrical heating element of each of the heating tiles is also electrically coupled to a female electrical coupling contained in a notch formed on a second side of said tile opposite the first side. The male and female couplings are configured and the notches are positioned such that when two of said heating tiles are abutted together in side to side orientation, the male coupling of one heating tile is aligned with and can couple to the female coupling of the other tile.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a perspective view of a radiant heating tile made in accordance with the present invention and having four electrical connectors.

FIG. 2. is a perspective view of a radiant heating tile made in accordance with the present invention and having two electrical connectors.

FIG. 3. is a top view of a radiant heating return tile made in accordance with the present invention showing some of the internal structure.

FIG. 4. is a top view of an alternate embodiment of the radiant heating return tile made in accordance with the present invention showing some of the internal structure.

FIG. 5. is a perspective view of the heating tile shown in FIG. 1 without showing the electrical connectors.

FIG. 6 is a cross sectional view of the heating tile shown in FIG. 5 through line A-A.

FIG. 7 is a perspective view of two heating tiles made in accordance with the present invention being coupled together.

In the drawings like characters of reference indicate corresponding parts in the different figures.

### DETAILED DESCRIPTION OF THE INVENTION

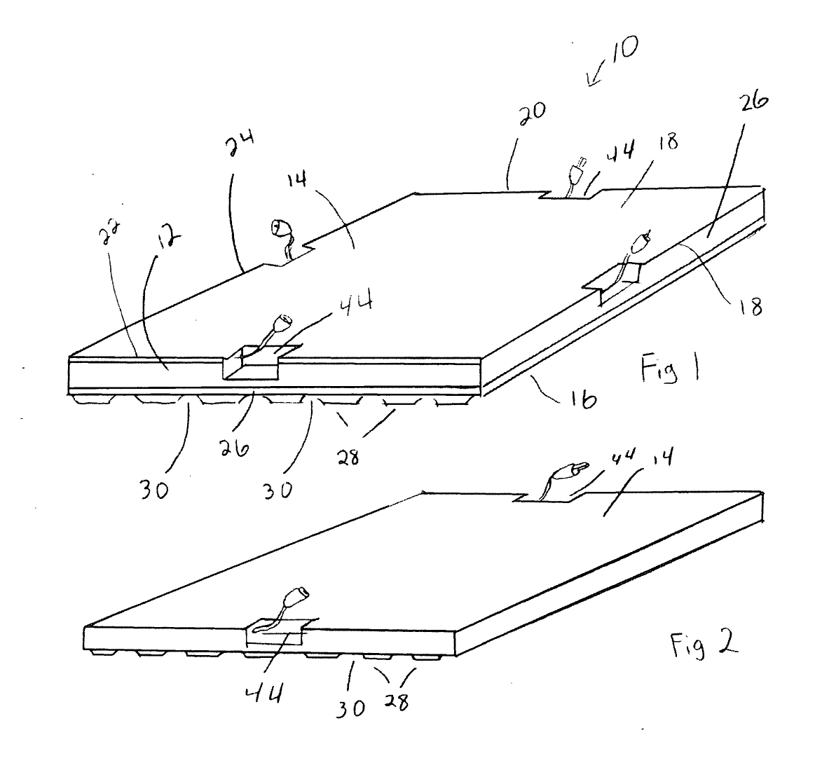

Referring firstly to FIG. 1, the present invention is a radiant “floor” or ground tile system comprising one or more tiles 10 which are mounted on a supporting surface (not shown) such as the ground. Each tile 10 has a core 12 preferably made of crushed stone, although other materials such as concrete or clay may be used. Core 12 has upper surface 14 and lower surface 16. Tile 10 is substantially flat such that the upper and lower surfaces are substantially parallel. Upper surface 14 is preferably covered by “rubber” matt 18 made from rubber (natural or artificial) or by some sort of plastic which adds to the water resistance of the tile. Lower surface 16 is covered by insulation layer 26 which helps reduce the loss of heat through the bottom of the tile. A plurality of feet 28 are formed on insulation layer 26 and are configured to support tile 10 above the supporting surface such as the ground. Channels 30 are formed between feet 28 and provide a passage for water to pass beneath the tile. These channels 30 make the tile particularly well suited to out door applications since it helps prevent the supporting surface from being undercut as a result of melt water or rain water. Furthermore, feet 28 ensure that the tile is not resting completely in contact with the supporting surface, thereby increasing the heat loss through the bottom of the tile. Tile 10 also has opposite sides 20, 22, 24 and 26 which are preferably encased in a hard plastic shell.

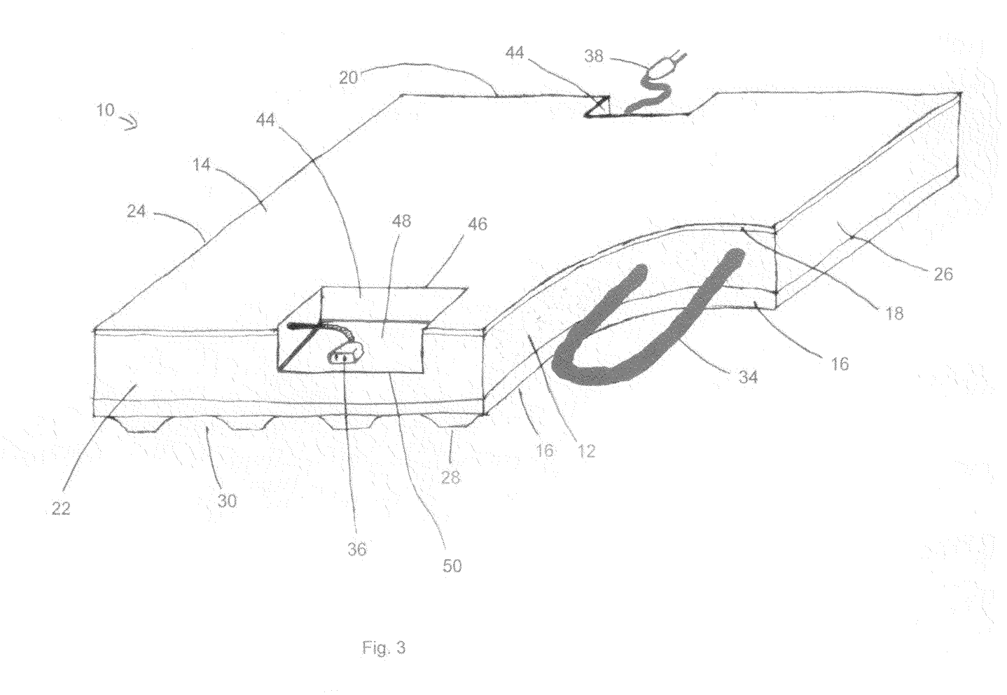

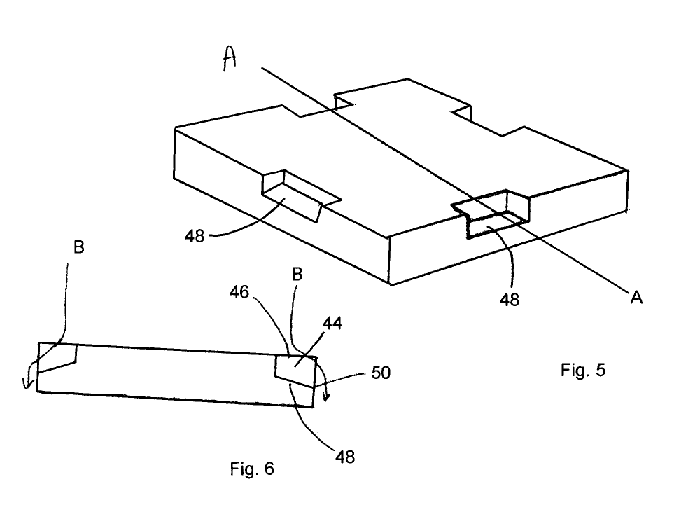

Referring now to FIG. 3, extending through core 12 is an electrical heating element 34 having opposite first and second ends electrically coupled to quick connector elements 36 and 38 located on opposite sides 22 and 20 of the tile, respectively. Preferably, connector element 36 is a female electrical connector and connector element 38 is a male connector element so that two adjacent tiles can be electrically coupled together. Electrical heating element 34 is configured to couple to connector elements 36 and 38 in a parallel fashion such that if two or more tiles are coupled together via electrical connectors 36 and 38, the tiles will form an electric circuit with the electrical heating elements in parallel, rather than in series. This permits the tiles to be coupled to a relatively low voltage power supply for providing sufficient electrical current to the electric heating elements to warm the tiles to a temperature slightly above freezing.

As seen in FIG. 4, it will be appreciated if a parallel circuit is to be achieved, then both ends of the electrical heating element 34 must be electrically coupled to electrical couplers 36 and 38; hence, each electrical coupler 36 and 38 must have two conductors, one conductor coupled to one end of heating element 34 and a second conductor coupled to an other end of the electrical heating element. Suitable electrical heating elements and suitable male/female connector elements are readily available in the market. FIG. 4 also shows how simple it is to create a tile having four electrical connectors coupled to the electrical heating element. To create a four coupling tile, a second pair of electrical connectors, 40 and 42, are coupled to the opposite ends of heating element 34 and are in turn located on opposite sides 24 and 26, respectively.

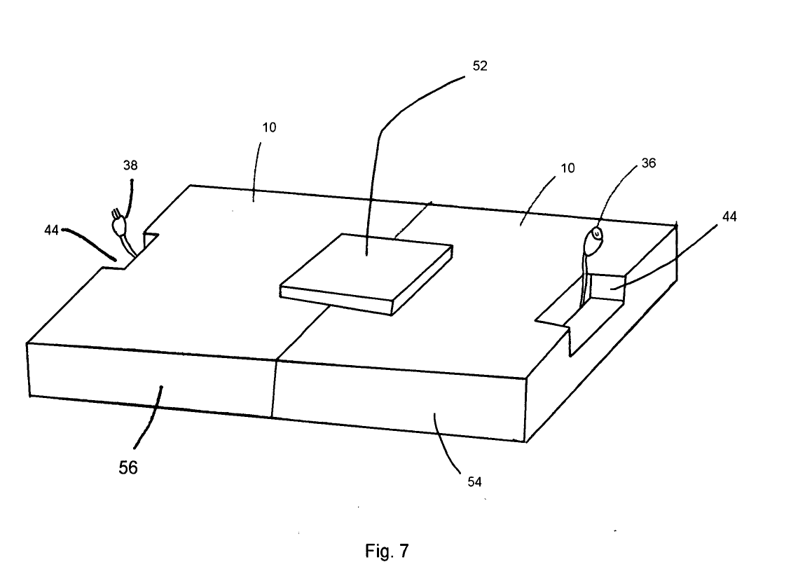

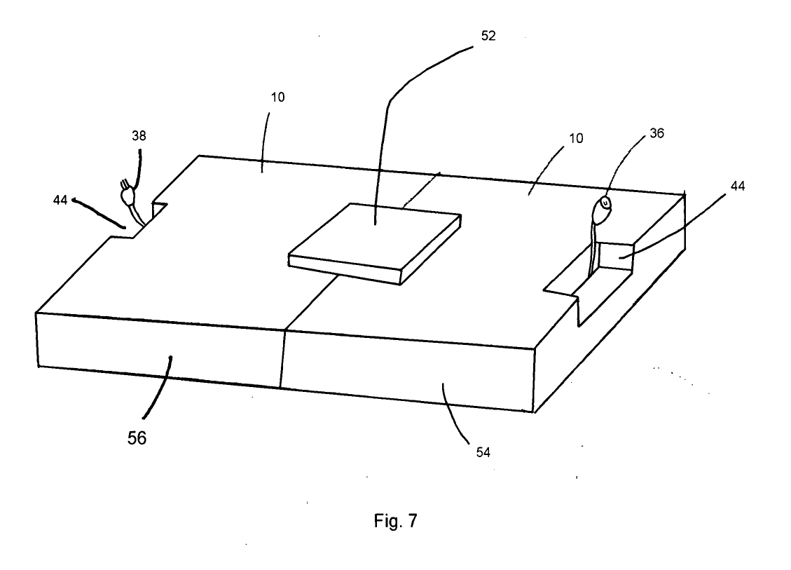

Referring back to FIG. 3, each electrical connector is retained in a recessed notch 44. Each notch 44 has an open top 46, and a ledge 48 which slopes towards a edge 50. As better seen in FIG. 6, sloping ledge 48 ensures that any rain water, which is indicated by arrows B, which enters notch 44 through opening 46 travels down and away from the tile. As shown in FIG. 7, cap 52 is configured to seal off openings 46 when a pair of adjacent tiles 10 are coupled together. When tiles 10 are coupled together as illustrated in FIG. 7, the two tiles (56 and 54) are brought together and their sides abutted together such that the male connector element of one tile is oriented and aligned with the female electrical connector of the adjacent tile. The female electrical connector element 36 of the first tile (tile 56) is then mated to male electrical connector element 38 of the second tile 54. Cap 52 can then be used to cover over the two aligned notches 44 to minimize the exposure of the coupled electrical connectors.

The present invention permits the coupling of several heating tiles together to form an electrically heated path. The electrical tiles are electrically coupled to each other, preferably in parallel, so that coupling one tile to a power supply has the effect of powering all of the tiles which are coupled together. The tiles which are coupled together form an electric circuit which can be coupled to a preferably low voltage power supply which is sufficiently powerful to heat the tiles in the circuit to a temperature slightly above freezing. Tiles having two electrical connectors can be used with tiles having four electrical connectors in order to create a variety of different shapes of heated pathway.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A radiant heating tile system for installation on a supporting surface comprising at least one heating tile, the heating tile comprising:
a substantially flat tile having parallel top and bottom surfaces and a plurality of sides;
a heating element passing through the tile substantially parallel to the top and bottom surfaces, and
a plurality of feet formed on the bottom surface for supporting the tile above the supporting surface.

2. The radiant heating tile system according to claim 1 wherein the heating element comprises an electric heating element coupled to a first and a second side of the tile with a first and a second electrical coupler, respectively.

3. The radiant heating tile system according to claim 2 wherein the first side of the tile is opposite the second side of the tile.

4. The radiant heating tile system according to claim 1 wherein the heating element comprises an electric heating element having opposite first and second ends and wherein the first and second ends of the electric heating coil is coupled to a first side of the tile with a first electrical coupler and wherein the first and second end of the electric heating coil is also coupled to a second side of the tile with a second electrical coupler.

5. The radiant heating tile system according to claim 2 wherein the first and second electrical couplers comprise male and female electrical couplers, respectively.

6. The radiant heating tile system according to claim 4 wherein the first and second electrical couplers comprise male and female electrical couplers, respectively.

7. The radiant heating tile system according to claim 1 wherein the heating element comprises an electric heating element having opposite first and second ends and wherein the first and second ends of the electric heating element are coupled to opposite first and second sides of the tile by first and second electrical couplers, respectively, and wherein the first and second ends of the electric heating element are further coupled to opposite third and fourth sides of the tile by third and fourth electrical couplers, respectively.

8. The radiant heating tile system according to claim 2 wherein the first and second sides of the tile each have a notch dimensioned to receive the first and second electrical couplers, respectively, and wherein the notches have an opening continuous with the top surface of the tile.

9. The radiant heating tile system according to claim 8 wherein the notches each have a bottom ledge which slopes downwardly towards an edge of the tile.

10. The radiant heating tile system according to claim 9 wherein the first side is opposite the second side and wherein the notches are positioned at a center of each side.

11. The radiant heating tile system according to claim 10 further comprising a plurality of cap portions, each cap portion dimensioned and configured to cover over the openings of the notches.

12. The radiant heating tile system according to claim 7 wherein the first side is opposite the third side and the second side is opposite the fourth side and wherein the notches each have a bottom ledge which slopes downwardly towards an edge of the tile.

13. The radiant heating tile system according to claim 12 further comprising a plurality of cap portions, each cap portion dimensioned and configured to cover over the openings of the notches.

14. A radiant heating tile system for installation on a supporting surface comprising:
a first plurality of heating tiles each being substantially flat and having a substantially equal thickness;
each of said first plurality of heating tiles having parallel top and bottom surfaces and a plurality of sides;
each of said first plurality of heating tiles having an electrical heating element;
the electrical heating element of each of said first plurality of heating tiles being electrically coupled to an electrical coupler contained in a notch formed on a first side of said tile;
the heating element of each of said first plurality of heating tiles being electrically coupled to an electrical coupler contained in a notch formed on a second side of said tile;
the electrical coupler being configured and the notches being positioned such that when two of said heating tiles are abutted together in side to side orientation, one of the couplers of one heating tile can be aligned with and can couple to one of the couplers of the other tile.

15. The radiant heating tile system of claim 14 wherein each of the notches have an opening on the to surface and further comprising a plurality of cap portions, each cap portion configured to cover over the openings of the notches.

16. The radiant heating tile system of claim 15 wherein the notches each have a bottom ledge which slopes downwardly towards an edge.

17. The radiant heating tile system of claim 16 wherein each of the cap portions are dimensioned and configured to simultaneously cover over the openings of two opposing notches on adjacent tiles.

18. The radiant heating tile system of claim 14 further comprising a second plurality of heating tiles, each of said second plurality of heating tiles being substantially flat and having a thickness substantially equal to the thickness of the first plurality of heating tiles;
each of said second plurality of heating tiles having parallel top and bottom surfaces and a plurality of sides;
each of said second plurality of heating tiles having an electrical heating element having opposite first and second ends;
each of said second plurality of heating tiles having first and second electrical couplers electrically coupled to the electrical heating element and third and fourth electrical couplers electrically coupled to the electrical heating element;
the first and second electrical couplers being contained in separate notches formed on adjacent first and second sides, respectively, of said tile;
the third and fourth electrical couplers being contained in separate notches formed on adjacent third and fourth sides, respectively, of said tile;
the electrical couplers and the notches of said second plurality of tiles being configured such that when a tile of the first plurality of tiles is abutted with a tile of the second plurality of tiles one of the couplers of one of said tiles is aligned with one of the couplers of the abutting tile.

19. The radiant heating tile system of claim 18 wherein each of the notches have an opening on the to surface and further comprising a plurality of cap portions, each cap portion configured to cover over the openings of the notches.

20. The radiant heating tile system of claim 19 wherein the notches each have a bottom ledge which slopes downwardly towards an edge.

21. The radiant heating tile system of claim 20 wherein each of the cap portions are dimensioned and configured to simultaneously cover over the openings of two opposing notches on adjacent tiles.

22. The radiant heating tile system of claim 11 wherein the cap portion is translucent and wherein at one of the notches contains a light emitter.
